(19) United States
(12) Patent Application Publication
(10) Pub. No.: US 2018/0025370 A1
(43) Pub. Date: Jan. 25, 2018

(54) METHOD FOR OPTIMIZING A CONSTRAINED PRODUCT PORTFOLIO TO CAPTURE MAXIMUM TARGET MARKET

(71) Applicant: SONY INTERACTIVE ENTERTAINMENT AMERICA LLC, San Mateo, CA (US)

(72) Inventor: Ankur Uttam, Sunnyvale, CA (US)

(21) Appl. No.: 15/216,886

(22) Filed: Jul. 22, 2016

(51) Int. Cl. G06Q 30/02

(52) U.S. Cl. CPC G06Q 30/0202

(57) ABSTRACT

The method and systems of the present invention is directed towards forecasting and modeling projected sales of a portfolio of products (e.g., video game/software titles) in order to obtain a corresponding projected sales of a platform (e.g., console). The method is aimed at maximizing the projected sales of the platform by providing saturation of targeted consumer segments (e.g., groups of users) of a total addressable market. In particular, the present invention takes into consideration the constrained resources (e.g., budget) that can be spent on various different products and partnerships in order to maximize platform sales.

### BACKGROUND

### Field of Invention

The present invention generally relates to managing a product portfolio. More specifically, the present invention relates to optimizing a constrained product portfolio in order to capture a maximum target market.

### Description of the Related Art

Marketing research is a process that can be used identify and assess how changing elements within a market impacts customer behavior. To carry out such research, a variety of different steps need to be performed. First, identification of the relevant information is performed. Based on the relevant information, methods for collecting the relevant information are designed. Afterwards, the methods are used to collect the relevant data that will subsequently be analyzed. Finally, any results are provided that can be used to inform relationships between products, consumers and the market.

In many cases, companies may perform this sort of marketing research by identifying particular target segments of customers (i.e. consumers) that they would like to appeal to. Products can then be made that target those specific segments. Afterwards, data can be gathered (e.g., purchases) that can then be used to evaluate whether such strategy of targeting a product towards the specific segment was effective. However, a problem is that such strategy is unclear (or the result is unknown) whether it is actually effective until the gathered data is analyzed. Furthermore, some companies may not have the resources (e.g., time, money) to perform such strategy.

As an example, given a period of time, a company may only have resources (e.g., money, time) to produce and/or market a limited number of products (e.g., software titles) associated with a platform (e.g., console). The company may wish to have a set number of products targeting the various segments (e.g., type of users) associated with the platform. Based on the products, the company may be capable of influencing the sales of the corresponding platform the products are used on/associated with. Therefore, an initial strategy may be to allocate a number of products targeting a segment based on historical data, for example, related to popularity and success. However, a risk arises if such initial strategy is based on out-of-date information or erroneous data that could place the success of the platform in jeopardy if the products are not allocated properly. Furthermore, the initial allocation may not take into account the resources available to the company.

There is a need in the art for a method that is capable of providing predictions that take into account the resources available. In particular, based on a portfolio of products (e.g., titles), the method determines allocation that maximizes saturation of targeted segments of a total addressable market constrained by the resources (such as money and potential third party title) available to the company.

### SUMMARY OF THE PRESENTLY CLAIMED INVENTION

A method for maximizing a projected number of sales of a platform based on forecasting and modeling projected sales of associated products in a constrained portfolio is presently claimed. Optimization of a constrained portfolio can be obtained by allocating available resources (e.g., budget) across various possible partnerships and spending (e.g., marketing). The method uses lists of software titles and bundles being sold associated with a platform. By forecasting sales for the software titles and bundles and associating the forecasted sales with the addressable market (or at least consumer segments within the addressable market), information about the forecasted sale of platforms can be obtained. The method then attributes individual sales of platforms with consumer segments within the addressable market using audience-based information. An optimized portfolio is obtained by looking at the various combination of how the available resources are spent and obtaining a combination that provides the best return on investment with respect to the most platforms sold.

A non-transitory computer-readable storage medium having embodied a program executable by a processor to perform a method of maximizing a projected number of sales of a platform based on forecasting and modeling projected sales of associated products in a constrained portfolio is presently claimed. Optimization of a constrained portfolio can be obtained by allocating available resources (e.g., budget) across various possible partnerships and spending (e.g., marketing). The method initially uses lists of software titles and bundles being sold associated with a platform. By forecasting sales for the software titles and bundles and associating the forecasted sales with the addressable market (or at least consumer segments within the addressable market), information about the forecasted sale of platforms can be obtained. The method then attributes individual sales of platforms with consumer segments within the addressable market using audience-based information. An optimized portfolio is obtained by looking at the various combination of how the available resources are spent and obtaining a combination that provides the best return on investment with respect to the most platforms sold.

A system for maximizing a projected number of sales of a platform based on forecasting and modeling projected sales of associated products in a constrained portfolio is presently claimed. The system includes memory and a processor that executes instructions stored in memory directed towards optimization of a constrained portfolio. Optimization can be obtained by allocating available resources (e.g., budget) across various possible partnerships and spending (e.g., marketing). The instructions include the use of lists of software titles and bundles being sold associated with a platform. By forecasting sales for the software titles and bundles and associating the forecasted sales with the addressable market (or at least consumer segments within the addressable market), information about the forecasted sale of platforms can be obtained. The instructions also are directed towards attributing individual sales of platforms with consumer segments within the addressable market using audience-based information. An optimized portfolio is obtained by looking at the various combination of how the available resources are sent and obtaining a combination that provides the best return on investment with respect to the most platforms sold

### BRIEF DESCRIPTION OF THE DRAWINGS

FIG. 1 illustrates a method directed at forecasting and modeling platform sales.

FIG. 2 illustrates an example database associated with the method for forecasting and modeling platform sales.

FIG. 3 illustrates a software title roadmap that includes all software title launches in a planned period.

FIG. 4 illustrates a table that includes projected sales of various software titles.

FIG. 5 illustrates a bundle roadmap for all bundles in a planned period.

FIG. 6 illustrates an embodiment of the media mix optimization.

FIG. 7 illustrates a table that summarizes and attributes platform sales.

FIG. 8 provides an exemplary comparison between the total available market with respect to pricing of the platform.

FIG. 9 illustrates a table that includes a collection of market research associated with a software title genre and elements associated with the software title level.

FIG. 10A-FIG. 10C illustrates charts that contains relationships between elements of a software title and their impact with different consumer segments.

FIG. 11 illustrates a user interface that lists the various elements associated with software titles.

FIG. 12 illustrates a chart usable to track lift based on each segment compared to a total addressable market.

FIG. 13 is a block diagram of an exemplary electronic entertainment system.

### DETAILED DESCRIPTION

Embodiments of the present invention correspond to a method directed forecasting and modeling projected sales of a portfolio of products (e.g., video game/software titles) in order to obtain a corresponding projected sales of a platform (e.g., console). The method is aimed at maximizing the projected sales of the platform by providing saturation of targeted segments (e.g., groups of users) of a total addressable market. In particular, the present invention takes into consideration the constrained resources (e.g., budget) that can be spent on various different products and partnerships in order to maximize platform sales.

As described below in further detail, the method of the present invention being described below (and implemented via a computing device) takes into consideration various different factors in order to more accurately project product and platform sales. By using the method to forecast and model how various products may perform in sales, a user would be capable of determining exactly what products should be selected and marketed in order to maximize platform sales based on constrained resources (e.g., available budget).

As used herein, the company may correspond to a company that is associated with a console that is the subject of the present invention for predicting how best to maximize sale of the console. For example, the company may correspond to Sony Interactive Entertainment while the console may correspond to the Playstation 4.

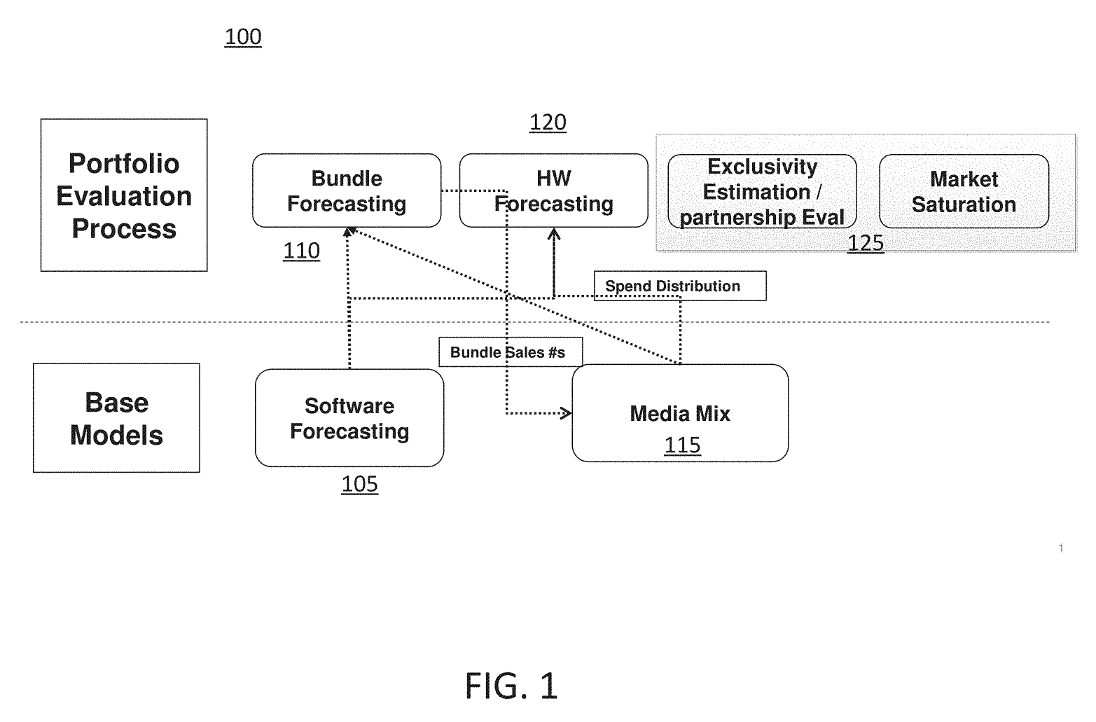

FIG. 1 illustrates a method 100 directed at forecasting and modeling platform sales. The method 100 can be broken into two parts. A first part of the method 100 incorporates software forecasting 105, bundle forecasting 110 and mixed media optimization 115 in order to forecast a number of hardware sales 120. Software forecasting 105 and bundle forecasting 110 evaluates how many software titles and bundle sales may be expected for a period of time. The media mix optimization 115 aims to allocate available spending (e.g., money) subject to business constraints (e.g., marketing, partnerships). By generating a model that uses the information from 105-115, a forecast can be performed that predicts how many platforms (e.g., consoles) that can be sold within a period of time.

A second part of the method 100 evaluates the forecasted number of hardware sales 120 influenced by the selected partnerships/exclusivity agreements used during the mixed media optimization 115. An evaluation is performed for each different combination of partnership/exclusivity agreements that may be available for use in the first part of the method 100 that best provides market saturation as evaluated in the second part of the method 100. Further details of the overall method 100 are provided below.

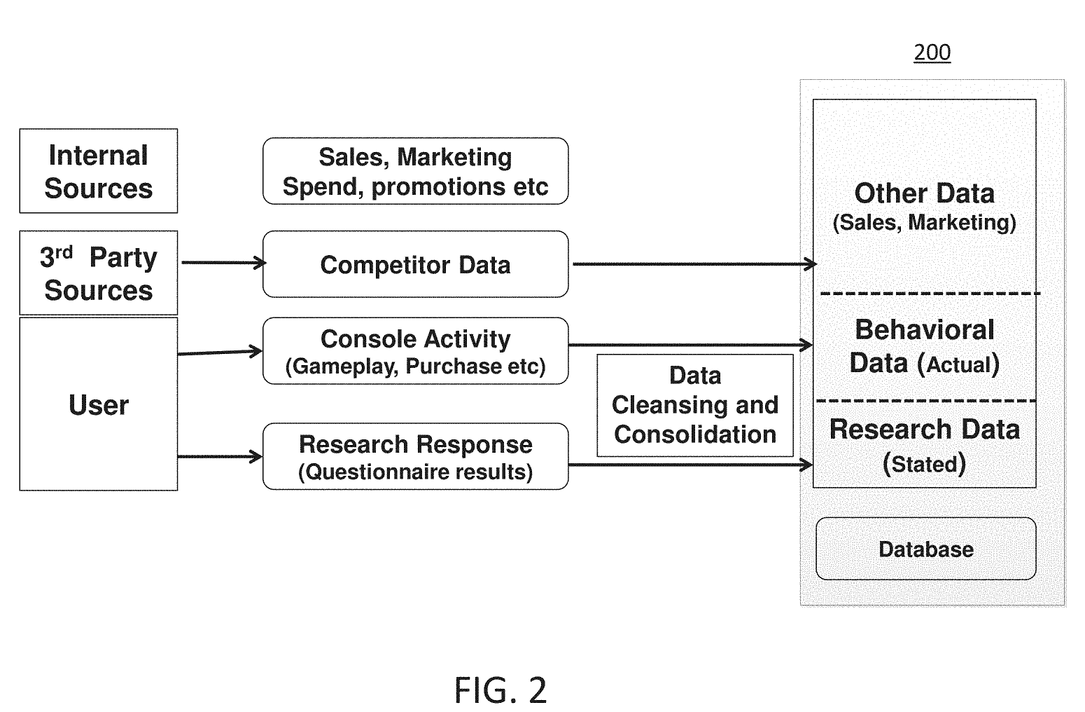

FIG. 2 illustrates an example database associated with the method for forecasting and modeling platform sales. The database includes all relevant information that can be used for the forecasting and modeling performed in the present invention. As described in further detail below, information that may be used in the method may come from various sources. Information may come within the company (e.g., internally), from third parties (e.g., competitors) or directly from potential users associated various consumer segments of an addressable market.

With each source of information, there may be different types of information that can be obtained. For example, internal information (associated with a particular company) may include information about sales, market spending and promotions. These sort of information may be useful in figuring out what type of software titles are being projected for a period of time and how successful these titles may be.

Third party data may include similar information but associated with competitor companies. These third party data may be available, for example, via subscription-based third party services that can provide similar information that can be obtained internally for first party products. Such information about competitors may be helpful in figuring out, for example, what competitive software titles may be available during the same time a first party software title is projected to be released.

Lastly, information about various users can be helpful in evaluating consumer segments in the addressable market. This information can be used to tailor software titles and other services towards users for greater appeal. User information can be obtained, for example, directly from users via surveys/questionnaires. Other user information can also be obtainable through monitoring of user profiles. For example, some companies may have users create user profiles associated with a platform. This information can be collected to evaluate, for example, what games (e.g., software titles) users have purchased and gameplay statistics (e.g., how often a user plays, for how long).

The overall method (for example, as described in FIG. 1) includes various steps that obtains a variety of information from the different sources (e.g., internally, third party sources, users). The obtained information may be stored in the database 200 for later retrieval in one or more subsequent steps that uses the information for various modeling and forecasting. Further details regarding the steps of the present invention and how the database 200 is incorporated is provided below.

The success or failure of one or more software titles associated with a platform may influence the sale of the platform. For example, if the platform has one or more successful software titles, this would influence users interested in playing those successful software titles to purchase the platform in order to play these software titles. However, if the software titles are not as successful, users may not be interested in purchasing the platform since users would not be interested in playing the unsuccessful software titles. This concept regarding software titles and their influence on forecasting platform sales is illustrated in FIG. 1.

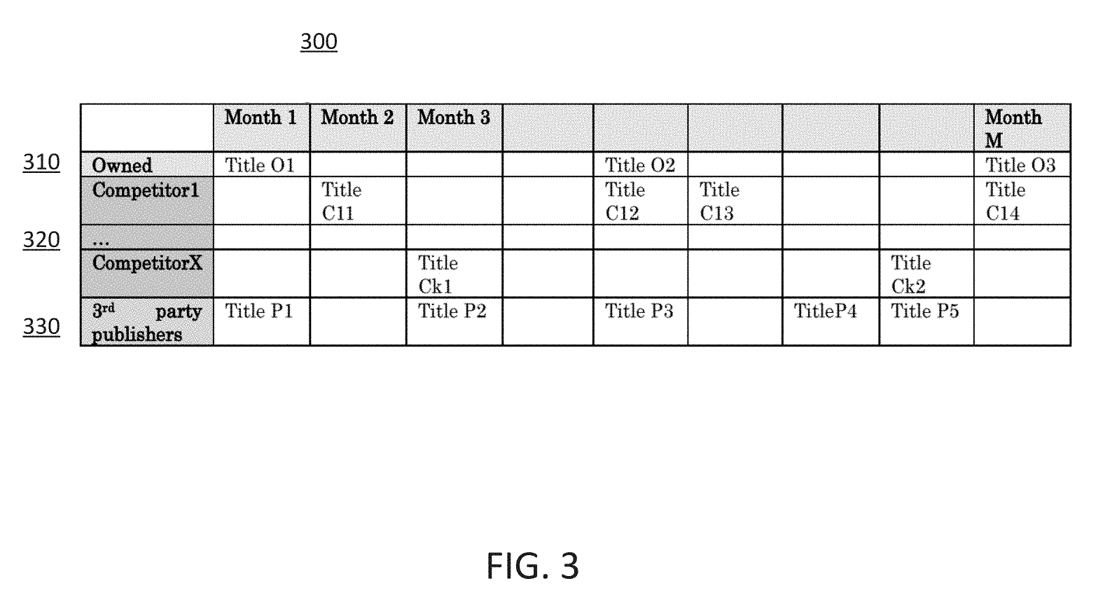

With respect to forecasting software title sales, FIG. 3 illustrates a software title roadmap 100 that includes all software title launches in a planned period. In particular, a first step for the method of forecasting platform sales is directed towards the creation of the software title roadmap 100 that lists all currently known/planned software titles (i.e. video games) within a period of time (e.g., quarterly, yearly). This software title roadmap 300 may be updated as needed, for example, when additional titles are discovered or announced. The software title roadmap 300 may also be updated when information about a particular software title corresponds to delays.

The software roadmap 300 may include titles from various different groups. As illustrated in FIG. 3, the software titles illustrated may be internal (or owned by the company) 310. These titles may correspond to software titles that are internally created by the company that also owns the corresponding platform for which the method is trying to predict and maximize the sale of. Generally this first group of software titles are referred to as first party titles.

The software title roadmap 300 may also include software titles associated with various competitors 320. These competitor software titles correspond to software titles that are being published by other companies (i.e. competitors) that are competing in the marketplace against the first party software titles being pushed by the company. These competitive companies may also include their own distinct platform that is also competing against the first party platform being pushed by the company.

Lastly, the software title roadmap 300 may include third party software titles 330. Generally, these software titles are owned and published by third parties distinct from the companies associated with platforms. Furthermore, these software titles may be platform independent (e.g., can be played on any number of platforms). Therefore, it may be a goal for a company to organize exclusive partnerships with particular third party titles in order to gain competitive advantages.

The purpose of the roadmap 300 is manifold. One possible purpose is to identify what first party software titles should be selected by the company for a pre-determined period of time 110. This may resemble ensuring that a set number of titles falling under genres (e.g., first person shooters, sports, role playing games) are available within a pre-determined period of time. In this way, a variety of different software titles across a variety of different genres would be available thereby appealing to a larger segment of the available market. As a general strategy, this would appeal to a larger range of potential users compared to an alternative situation where only one type of genre (e.g., first person shooters) is generally available within the same pre-determined period of time. Limits on what genres of titles are available within a pre-determined period of time may end up alienating a segment of potential users who may not be interested in the available genre of titles. As noted above, if users are interested in one or more software titles available on a platform, the users would be more likely to purchase the platform in order to play those available software titles.

Another purpose for the roadmap 300 is to identify what software titles should be selected compared to what software titles are available by the company's competitors 120. In particular, the company may also wish to plan software titles that correspond to similar software title releases by the competitors. For example, the company may choose to provide genre of software titles during period of times where such genres are not currently available by the competitor in hopes of attracting users who enjoy those genres to purchase these software titles. Alternatively, the company may choose to provide similar genre of software titles during periods of times where such genres are also available by the competitor in hopes of attracting users who enjoy those genres to purchase these software titles instead of the competitors.

The information associated with third party publishers 330 can also be used to supplement the information associated with what is currently being pushed by the company 310 via first party software titles. As described in further detail below, software titles associated with third party publishers correspond to software titles that are published by third parties but are subject to an agreement (e.g., exclusivity) that allows these software titles to be associated with the company's platform. Although these third party software titles may be playable on competitor platforms as well, the third party agreements may include various features or benefits associated with playing the third party software title on the company's platform that could influence potential users to buy the company's platform over the competitor.

The information listed corresponding to third party publishers 130 would be helpful, for example, in filling in the gaps of what genres are currently unrepresented by the company in 110 via their first party software titles. For example, if the company knows that various first person shooters and sports games are available in a pre-determined period of time, the company may seek to make various third party relationships with potential software titles falling in other genres (e.g., role playing games). This is to provide wide coverage on available titles for the platform that would best appeal to the broadest number of users in the addressable market.

The data provided in the roadmap 300 may be acquired by various methods known in the art. As described in FIG. 2, first party data (associated with software titles described above with the company) may already be known based on internal planning within the company. With respect to competitor and third party data (associated with software titles), this may require some research by the company or acquiring such information via subscription-based services from outside parties. The research may require that the company gather information about future software titles by gathering information through announcements made by the competitor and third parties via various sources such as websites and blogs. In the end, the data acquired by the methods described above, may subsequently be inputted into the roadmap 300 and stored in a database (see, e.g., FIG. 2).

Once the software title roadmap 300 of FIG. 3 is created, a second step directed towards forecasting the expected number of sales of the listed software titles is performed. The output of this step is a key input, for example, in informing the company what partnerships the company should enter into with third party publishers. Presumably, the company would like to partner with third party publishers that project a high number of expected sales for their software titles.

The forecasting of the expected number of sales of the listed software titles is performed using a method that takes a variety of factors (i.e. independent variables) and develops a log-linear regression model used to predict software title sales. In particular, the log-linear regression model itself uses the following mathematical equation: Log(Var₁)=f(Var₂, Var₃ . . . Varₙ). With respect to the equation, Var₁ is the variable being forecasted while Var₂ through Varₙ are independent variables that influence the sales of Var₁.

The forecasting method uses a set of independent variables (e.g., Var₂ . . . Vₙ) that can be chosen from a list of all possible independent variables (inclusive of derivatives as well) that could potentially influence product (e.g., software title) sales. Some examples of independent variables may include marketing ad stock (e.g., resources the company devotes to marketing a software title), competitive product ad stock (e.g., resources a company's competitor devotes to marking their software title), seasonality, install base of the platform and decay rate of sales. Additional independent variables may also include genre, price, franchise, and events.

With respect to competitive product ad stock, sales of any one particular software title can be impacted by the quality and quantity of other products (e.g., software titles) released around the same time. Furthermore, this independent factor includes multiple levels (i.e. derivatives) that can correspond to other factors such as the strength of competitive products, the competitive products being created by the same or different companies, the competitive products belonging to the same or different genre, etc. . . . .

With each possible independent variable, a corresponding determined effect to the product sale is known. The effect may take into consideration different functional forms and latency effects associated with each independent variable. All these effects are known based on, for example, past data related to similar software titles.

Once all the independent factors and corresponding effects have been listed, the method then performs analysis on different combinations of the independent variables. The purpose of the analysis is to find the combination that provides not only the most accurate model based on a pre-established set of criteria but also to provide a model that is aligned with business logic (e.g., satisfies the constrained resources such as time and budget).

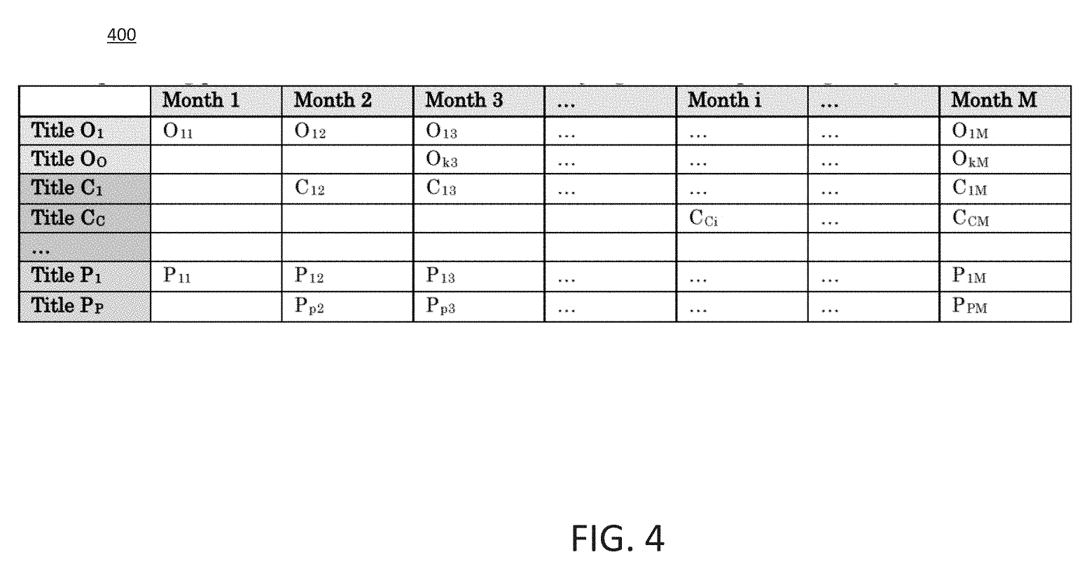

The method for forecasting the expected number of software title sales uses data associated with each software title listed on the roadmap. The forecast can take into consideration the variety of factors for each software title (e.g., first party, third party, competitor). By incorporating the various factors into the log linear regression model, an outcome of projected sales for each of the software titles on the roadmap can be obtained. The projected software title sales may be provided for various pre-determined periods of time (e.g., weekly, monthly, quarterly). An example table 400 illustrating the projected sales of the software titles can be seen in FIG. 4.

Similar to the software title roadmap of FIG. 3, the table 400 of FIG. 4 lists all the known software titles from the company, competitors and third party publishers. Furthermore, the table 400 provides for each of the known software titles, a predicted number of sales for various time periods. For each column identifying a period of time (in this case the period of time is measured in months), a predicted number of sales is provided starting with the time period the software title is expected to be released.

It should be noted that selection of particular software titles is not the only way that the company can try and promote the sale of the platform. It may also be possible to incorporate bundles to help promote the sale of the platforms. Generally bundles include multiple products packaged together with an added benefit such as a slight discount or an exclusive reward. By encouraging/enticing users to purchase the bundle, users may subsequently seek to purchase the corresponding platform in order to utilize the bundle (assuming that the purchased bundle does not already include the platform itself).

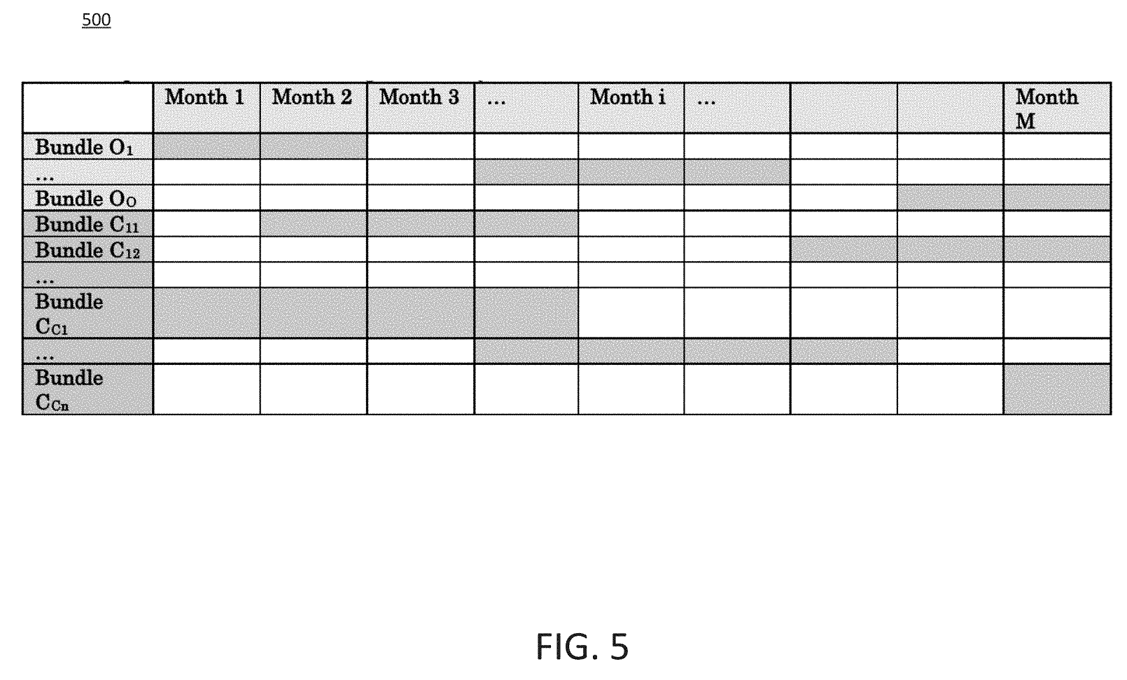

Similar to the software title roadmap, the company may wish to plan and take into account competitor bundles when choosing what to bundle and how to market particular bundles. FIG. 5 illustrates a bundle roadmap for all bundles in a planned period.

As noted above, a bundle may refer to a combination of two or more software titles. Alternatively, software titles can be combined with other non-software products such as hardware (e.g., consoles, peripherals) or other rewards such as non-game related accessories, subscriptions or discounts. Generally, these bundles include multiple products provided for the potential user to buy as an overall package. The package may be uniquely themed and may provide a discount compared to if the potential user bought the components of the package separately.

Similar to how planning software titles over a period of time is important as described above with respect to FIG. 3, the company may need to similarly plan how bundles are scheduled over a period of time. Such planning could ensure that minimal overlap occurs between multiple bundles of one type from being marketed by the company (or contracted third party publishers) that would negatively affect the sale of one or more of the bundles. For example, it may not be ideal to provide multiple bundles consisting of a software title and a console within a short amount of time on the basis that most users will not buy the same console multiple times even if they appear in bundles that would appeal to a broad number of users.

In this way, the bundle roadmap 500 in FIG. 5 can illustrate when bundles are marketed. Furthermore, the bundle roadmap 500 can illustrate when overlap exists between two or more bundles being marketed by the company and/or competitor.

As provided above with respect to software titles, providing bundles that coincide with competitor bundles may similarly attempt to persuade potential users into purchasing the company's bundles over the competitor's bundle. In situations where a user's resources are limited (e.g., time, money), the more appealing bundle can be used to draw potential users into purchasing the company's bundle. The more bundles the company sells, this sale also influences the number of sales associated with the company's platform.

There may also be many considerations that go into deciding what should be bundled together aside from what was provided above. For example, the company may choose to bundle other products (e.g., software titles, accessories) that do not compete directly with the company. Furthermore, products (e.g., software titles associated with a successful franchise) that are popular with potential users can influence the purchase of a bundle. The company may also consider providing bundles during particular times (i.e. holiday season) where high user purchase activity exists. Additionally, bundles may include products (e.g., software titles) that are less represented in the current company roadmap (e.g., directed towards particular genres) thereby capturing potential users who may not be currently covered. Finally, bundles may include various products (e.g., accessories such as a special peripheral or controller) that would be necessary for the corresponding bundled software title.

In some situations, the decided bundle may also need to take into consideration a ‘value’ that could appeal to the potential user. Furthermore, the type of bundle being marketed would have different effects on promoting platform sales. For example, a bundle that consists of multiple titles could impact the sale of consoles more differently compared to a bundle that consist of a single title and the console itself based on the strength of the software titles being bundled. In a situation where a potential user is interested in the single bundled software title with the console, that user may be interested in purchasing the latter bundle. However, if the potential user is not interested in the bundled software title, the appeal of the bundle may be diminished thereby resulting in a lesser number of sales of the bundle overall.

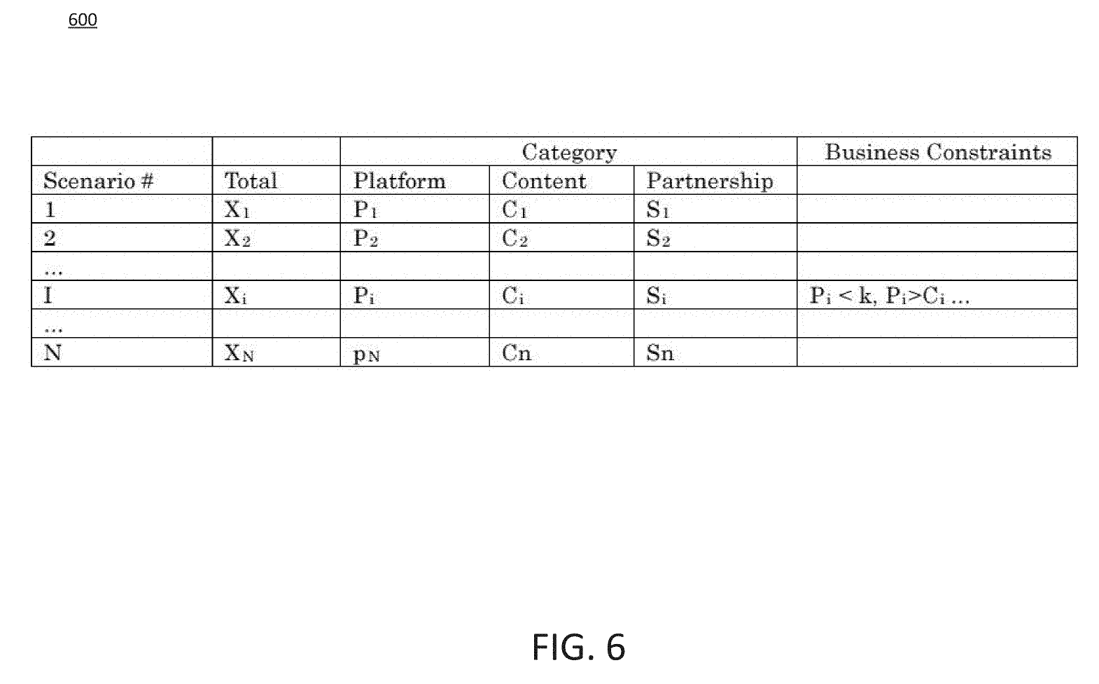

FIG. 6 illustrates an embodiment of the media mix optimization. In particular, FIG. 6 illustrates various scenarios aimed at maximizing a set of metrics under provided business constraints. In particular the media mix optimizer (MMO) works on a basic principle for maximizing a set of target business metrics (such as profits for the company) across different product categories (such as platform, first party content and third party partnerships) with various business constraints (e.g., budget). The table 600 illustrated in FIG. 6 provides examples of how available resources (e.g., money) can be distributed across the different categories. The output for the media mix optimization is a distribution for the target business metric that would provide the best return on investment (e.g., increase in platform sales and/or profits) across the different categories but within various business constraints.

After performing the media mix optimization (as illustrated in FIG. 6), the present invention would subsequently perform a forecasting of an expected number of sales for the platform. The forecast for the platform would be influenced by the information obtained above with respect to the software forecasting, bundle forecasting and the media mix optimization. It should be noted that this forecast of expected number of sales for the platform is considered novel over the existing art because existing companies have not yet considered using these types of information regarding sale of software titles, and bundles collectively to forecast platform sales.

The forecast for the expected number of sales of the platform can be calculated in a similar manner as described above for the expected sales of the software titles and bundles. A variety of factors can generally influence the expected sales of platforms. Some of these factors are similar to factors that are capable of affecting the expected sales of the software titles described above such as seasonality, events, selection of particular partnership/exclusivity agreements, allocated marketing budget, and competition. Further details regarding some of these factors are provided below.

Associated with the marketing budget, it is known that resources could be spent on a number of different ways. Marketing can be associated with television advertisements, digital advertisements and trade. For example, with respect to television-related marketing, resources can be attributed to marketing campaigns run on various television channels (cable and/or network). With respect to marketing in the digital realm, digital advertisements can be provided. For trade, resources can be spent on providing for in-store (i.e. brick-and-mortar locations) advertisements and promotions that the users can view. Furthermore, vouchers and coupons can also be provided.

Resources spent on one or more different types of marketing have been shown to have a correlation with respect to expected sales of platforms and titles. There is also some correlation that can be found with respect to when the resources are spent on marketing (e.g., around launches, announcements or events).

Based on the extent of a marketing campaign to advertise for a platform or title, a correlation between the resources spent and the expected sales of the platform can be proposed with various models. For example, a more conservative model (i.e. one that uses fewer variables) may be used to forecast predicted sales when a number of marketing campaigns is low.

As noted above, partnership agreements with third parties can also be used to influence expected sales of platforms. As used herein, partnership agreements generally include an element of exclusivity in content that is associated with the platform. In other words, any potential user who would want access to this exclusive content subject to the agreement would need to buy the software title and use the company's platform associated with the partnership agreement.

Exclusive content can be viewed as being a number of different features. At one extreme end, exclusivity through a partnership agreement with a third party can dictate that the third party software title can only be played on the company's platform. However, exclusivity also covers situations where the third party title can be played on multiple platforms as well so long as some feature (e.g., content, condition) is special to the company's platform. Various other examples of exclusivity may include allowing users associated with the company's platform early access to the software title before other users, access to special in-game content only playable on the version compatible with the company's platform during the software title's launch, access to special in-game content after the software title's launch (i.e. via download content) or marketing of the software title directed only for the company's platform (although this does not limit the software being played on other platforms as well).

Aside from the feature of exclusivity associated with the third party title, the further consideration whether the company should enter into a partnership consideration may also be based on the expected sales of the third party software title (e.g., popularity/franchise) and whether the provided exclusive content affects the expected sales of the platform. There may be situations where the exclusive content associated with a third party title is highly desired while other types of exclusive content may be less desired. The exclusivity may be an additional independent factor (as described above) that can be used when correlating how well a third party software title may perform in sales with particular exclusive content and in turn affect the sale of the company's platform.

With all the forecasting of the software title sales (first party and partnership) and sale of bundles, another novel step used in the present invention is to properly attribute how platform sales are affected. By being able to figure out how the sale of platforms is broken down, re-allocation of resources towards first and third party partnerships and bundles can provide different outcomes to the forecasted sale of platforms.

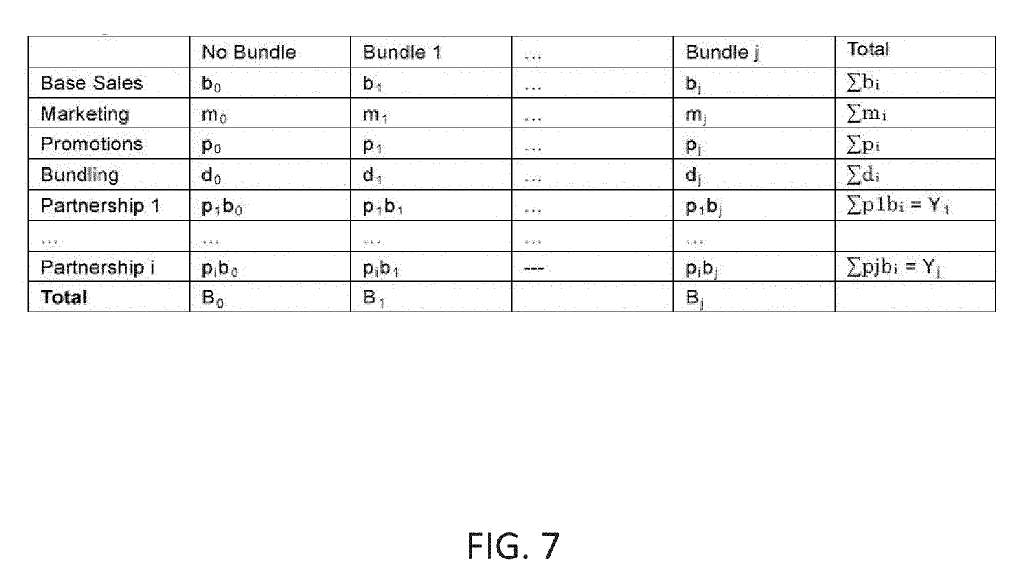

FIG. 7 illustrates a table 700 that summarizes and attributes platform sales based on the various methods that may be used as described above (e.g., software title forecasting, bundle forecasting). This step of identifying where platform sales may be attributed is another novel feature that is not currently performed in the art because typical companies do not consider this level of granularity with respect to data about platform sales. By using the table 700, a company can determine what type of strategies can be selected in order to better obtain additional sales of platforms.

In this step, platform sales are evaluated based on various factors, for example, marketing, title sales (both first party and partnership titles) and bundle sales. Each of the variables is accounted for with respect to correlation with the forecasted platform sales. Similar to how different independent variables are accounted for when forecasting the sale of software titles, a regression model is also used to forecast platform sales using a variety of variables. Each of the variables used in forecasting the sale of platforms is also evaluated in view of base sales and marketing impact for the platform. In particular, base sales refer to sales that would have happened without input from the company. For example, these sales would exist if no bundles were provided, market activity implemented or partnerships pursued. These sales may correspond, for example, to loyal users who may typically buy each new platform from a particular company. Meanwhile, resources provided towards marketing that incrementally increase the forecasted sale of the platform correspond to the marketing impact for the platform.

The method of the present invention, in order to determine what software titles (e.g., third party titles) should be chosen, also needs to evaluate what potential users across an addressable market can be targeted (e.g., via marketing). In order to facilitate this analysis, information about the target audience is collected. As noted above, with respect to FIG. 2, this audience-based data can be collected a number of ways. For example, the target audience data can be collected via various surveys provided to users within the addressable market. These surveys can request particular data from the user directly such as the type of software titles they enjoy playing or how long they may play. Alternatively, the target audience data can also be collected via the company from the users directly. In some situations software titles and/or platforms may have a user create and associate a user profile. The user profile may track various types of behavioral data such as the software titles the user may be playing recently and for how long.

The collected information for the target audience can be used for a number of reasons. First, the information can identify a complete available customer base of potential users and break down the complete customer base into segments. Second, the information can relate to reactions (positive or negative) regarding content associated with bundles or titles released for the platform. Third, the information can also provide information about the success of the company's competitors especially in situation where a third party title is playable on multiple platforms. Lastly, the information can provide a propensity of users to switch between platforms (company's platform to competitor's platform and vice versa). It should be noted that this fourth type of information is helpful for figuring out likelihood of a particular type of user to switch based on exclusive content in situations where the third party title is playable on multiple platforms. In general, information about a target audience (and in turn about a particular user) can be used to measure a user's preference/affiliation to particular features/characteristics associated with potential software titles. Further details regarding these four types of information and how they are used to characterize target market/consumer segments are provided below.

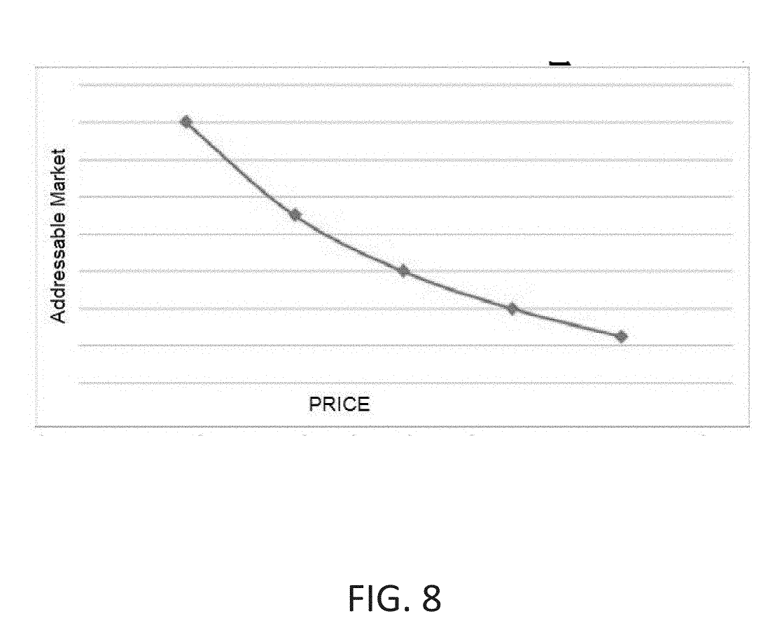

As noted above, identification of a total addressable market (or TAM) is first performed. There are a number of considerations that go into determining what the total addressable market is. For example, a factor may consider a total number of users who would be willing to pay for the console's current price. FIG. 8 provides an exemplary comparison between the total addressable market with respect to pricing of the platform. The graphical representation illustrated in the figure addresses a total market that is broken into segments associated with pricing that each segment is willing to pay. The more expensive the platform is, the less number of potential users may be willing to purchase the platform. However, making the platform cheaper is also not ideal since it decreases to the profits made by the company. Therefore, a balance between the price and the available target is typically implemented.

Generally, the total addressable market at a particular price point corresponds to the following equation TAM=X+D−U−C where the total addressable market at particular segments corresponds to TAMᵢ=Xᵢ+Dᵢ−Uᵢ−Cᵢ. With respect to the equation, X corresponds to the group of potential users associated with the total addressable market. D corresponds to dual console owners who are users who own multiple platforms (e.g., company's and competitor's) simultaneously. The equation also takes into consideration users who previously purchased either the company's current platform (characterized as U) or a competitor's platform (characterized as C) but do not own the other (i.e. users who are not dual console owners).

As noted above, the total addressable market can be broken into particular segments. These segments (described in further detail below) can correspond to further factors used to characterize behavior of various users within the smaller segment. These segments may be weighted, for example, based on their expected market share of the platform.

A feature used to characterize each of these smaller segments can be related to a target audience affinity. The target audience affinity uses elements and characters of various software titles and gathers stated and calculates behavior association of the audience with those elements and characteristics. For example, some elements associated with gaming may characterize the type of in-game environment (e.g., linear, open world), implementation of a story (e.g., no story, single path, multiple path), user perspective within the software title (e.g., 1^{st} person, 3^{rd} person, top down), genre of the software title (e.g., first person shooter, action, role playing game, sports), ERSB rating, pacing, multiplayer capabilities, customization, etc. . . . .

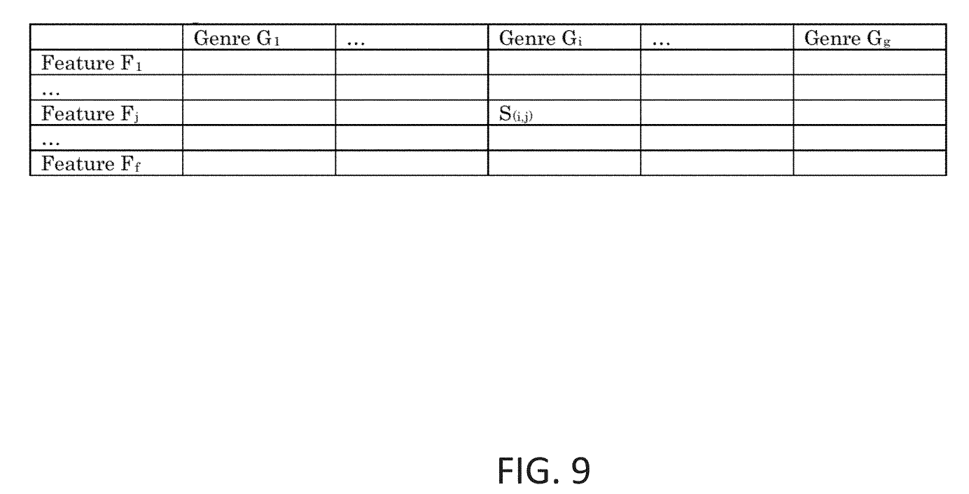

It is important to look at both the stated and behavioral preference of the user since there may be situations where the two are not the same (e.g., John indicates he enjoys playing sports games but recently has been spending time playing first person shooters. The stated preferences can be collected via continuous market research that provides representative data for the population. FIG. 9 illustrates a table that includes a collection of market research associated with a software title genre and elements associated with the gaming level. In particular, each column represents a preferred feature that users associate with respect to each genre. A particular cell provides a percentage of the population that prefers that feature with the particular genre.

With respect to behavioral preference, this information can be collected from actual game play data for content similar to the content under consideration (e.g., new titles). As described above, user play behavior associated with the company's platform is available to the company through extensive tracking and big data infrastructure. The company can gather this information associated with each user via user profiles to know how each individual users (as well as users within each segment) spend their actual time on different software titles (and other content) available on a platform.

Information about users association with different platforms as well as a particular user's propensity to switch between platforms is also collected. Such association data may be collected via surveys. Users may associate with different platforms or switch between a company's platform to a competitor's platform (or vice versa) for many reasons. For example, consideration on whether a user associates or switches to a particular platform may be influenced at the franchise/exclusivity of a particular software title playable on the platform.

It should be noted that similar software titles can be evaluated based on common elements within the software title, genre and/or franchise. Software titles may be attributed with one or more elements that describe the software title. For example, some elements may include descriptions related to the world (e.g., linear, open world), story (e.g., no story, single path, multiple path), perspective (e.g., 1^{st} person, 3^{rd} person, top-down), genre (e.g., shooter, action, platformer, role-playing game), pace (e.g., slow, deliberate), ESRB rating, whether multi-player exists, customization, user interactions, realism, any needed peripherals and mechanics (e.g., shooting, puzzles, climbing, stealth). These elements can characterize software titles into similar groups and related information about sales for these software titles can be used to forecast sales for newer software titles that have these similar elements.

With each element attributed to a particular software title, a further evaluation can be performed that characterizes an extent that the element is present within the software title. For example, the story element (e.g., single story) that is attributed to the software title may only sparingly while another mechanics element (e.g., shooting) may occur more frequently. It would follow that these elements can be weighted accordingly based on their presence/impact within the software title.

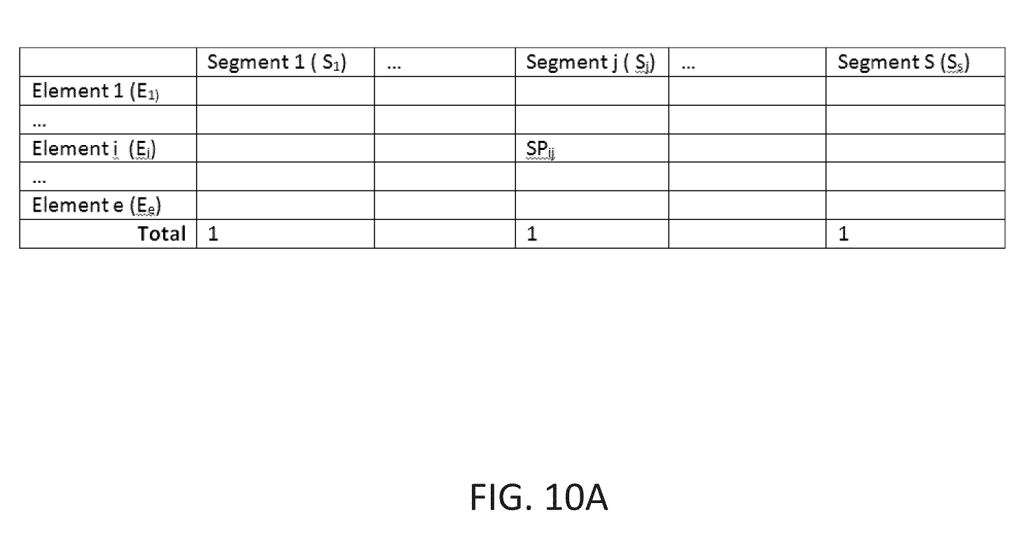

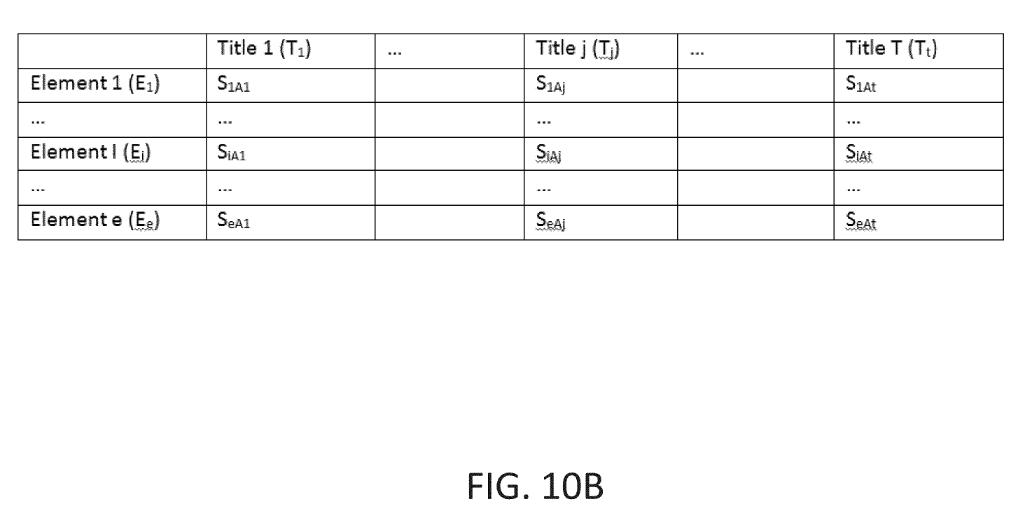

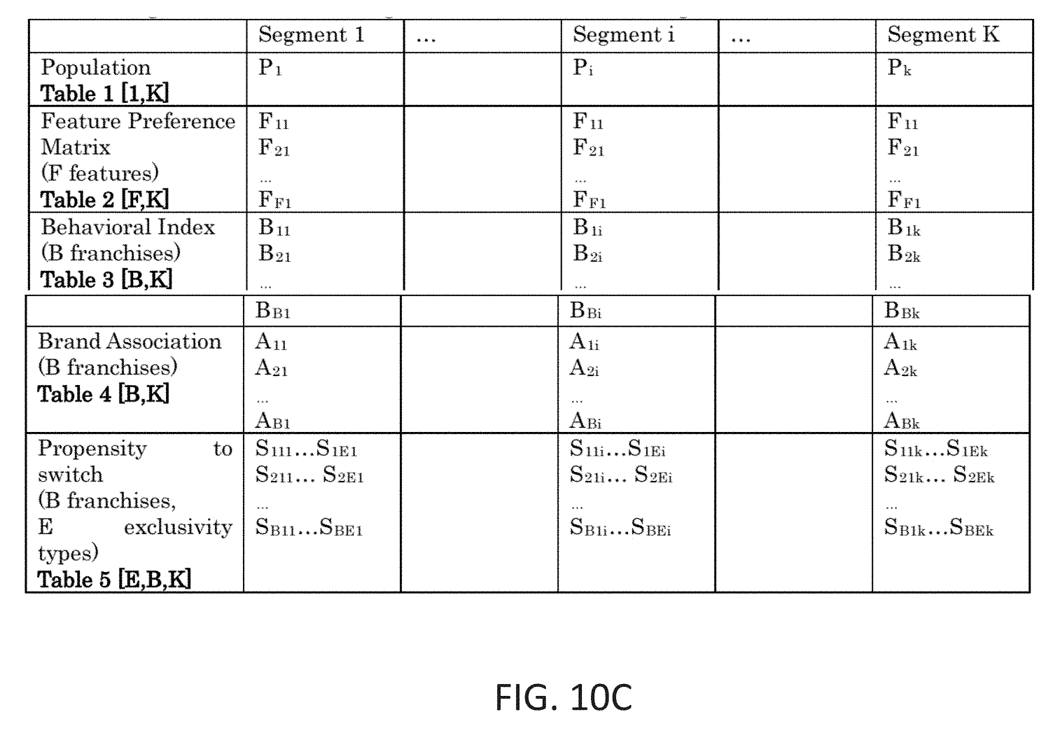

FIG. 10A-FIG. 10C illustrate charts that contain relationships between elements of a software title and their impact with different consumer segments. In particular, the chart shows a breakdown of various consumer segments and how each of the elements attributed to a particular software title impacts user preference for that game within each consumer segment. As indicated above, an impact of a particular element within a software title can be provided a weight with respect to other elements within the software title. The sum of the weights (i.e. preference score) can be normalized to one so that comparisons can be made between different consumer segments and for different combinations of elements.

With reference to FIG. 10A, information about users in various segments is captured through continuous research and updated periodically regarding changing user preferences. It may be possible that different segments will show different preferences for the same element of gaming. This information is collected for each genre of gaming and is normalized to one.

With reference to FIG. 10B, similarities between software titles can be compared. In particular, elements present in one software title can be compared with elements in other similar software titles. For example if a software title A is being considered (e.g., whether to pursue production, marketing), other related titles (T₁−Tₜ) may be evaluated. A similarity between the titles (labeled as S) is created by calculating overlapping elements of gaming between the software title A and other related titles T₁−Tₜ.

Any matches between Title A and related titles (T₁−Tₜ) are considered. Although software titles of the same genre are generally selected, software titles from non-related genres can also be considered if they share some similarities, for example, with elements associated with the software title being considered. The list of matching titles can be sorted in descending order based on the degree of matching between Title A and the related titles.

With the list of matching titles, typically the top two to five titles are considered for forecasting purposes. In the case of ties, particular elements can be further compared based on a relative importance for particular consumer segments.

After calculating the matched games, the stated preferences for various users are evaluated. The stated preferences, as noted above, can be obtained by evaluating actual game play data. Such game play data can be obtained from user profile data that tracks and monitors, for example, what software titles the user has been playing and for how long.

Furthermore, user behavioral preference is calculated from actual game play data for content similar to the software title under consideration by looking at behavior of users for the matched titles. Similar software titles are evaluated against the title under consideration based on commonality of elements as well as related genres and/or franchises. Once a list of comparable titles is found (e.g., titles that have at least an 80% match), the behavior of users associated with the matched similar software titles is evaluated at in order to understand differences (if any) between users across the various consumer segments.

With reference to FIG. 10C, a combination of information from FIG. 10A and FIG. 10B along with the stated preference and behavioral preference data of users is compiled. The figure also incorporates other audience-related data such as brand association and propensity to switch.

One all the above information is gathered, the present invention subsequently seeks to separate information about the platform sales into corresponding target segments. In other words, sales of software titles and bundles within each target segment can correspond to a number of platforms sold. The comparisons made above, with respect to the different consumer segments and software titles, are used to attribute a number of sales (or percentage of overall sales) for software titles for each consumer segment which in turn translates to a number of platforms sold.

The splitting of the platform sales is also facilitated by figuring out the stated feature and behavioral feature preference score and weighting the two sets of scores accordingly for each user/target consumer segment. Furthermore, information related to user association and propensity to switch between platforms is gathered (e.g., research).

By using the forecast for software title sales across each consumer segment along with stated and behavioral preference data, the method of the present invention can calculate lift distributions for each platform. These lift distributions would attribute a corresponding number of platform sales, for example, for each consumer segment.

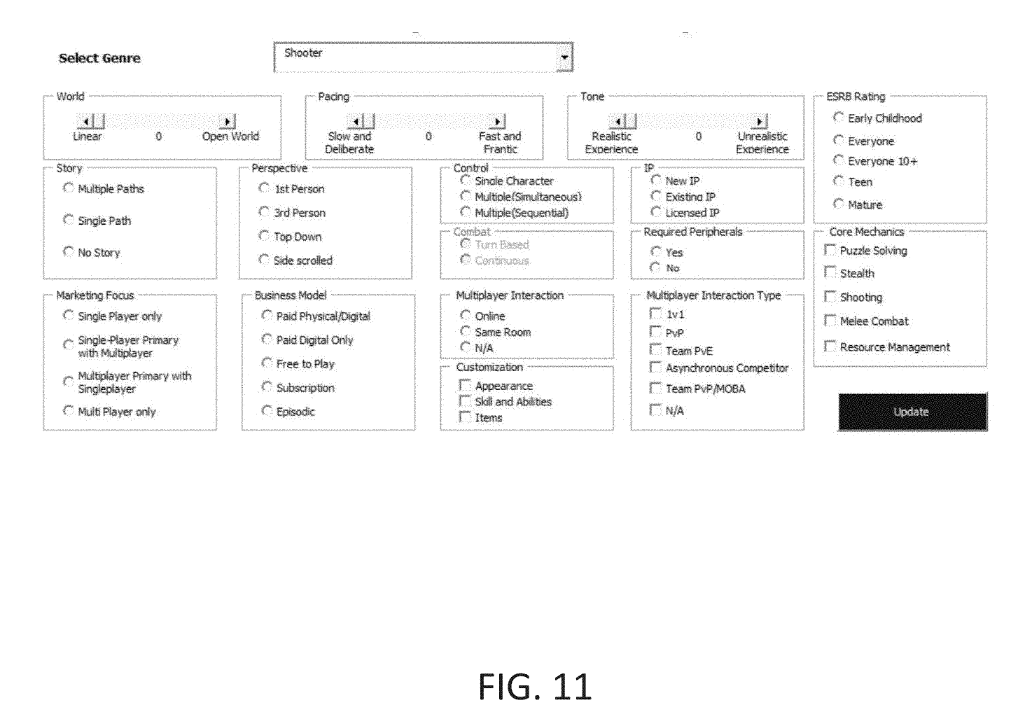

FIG. 11 illustrates a user interface that lists the various elements that can be associated with a software title. The user interface uses the information collected, for example, in the audience-based information and related software-title data for various elements associated with a software title. The user interface can be provided various inputs corresponding to elements for a possible new title (i.e. software title in consideration) to retrieve related information about a particular associated consumer segment. The information obtained from the inquiry would correspond to software titles having similar elements. For example, the inquiry could provide a forecast for the sale of the software title. Use of this information can influence whether the company should pursue a particular having the inputted elements or different titles having various different combination of elements. Alternatively, this information can also influence partnership deals for software titles from third parties.

In a next step, calculation of all partnerships is performed in order to evaluate how each of the features (described above in the earlier steps) contributes to the coverage of the addressable market. In particular, information regarding corresponding lift for each feature (e.g., bundles, software titles) is obtained.

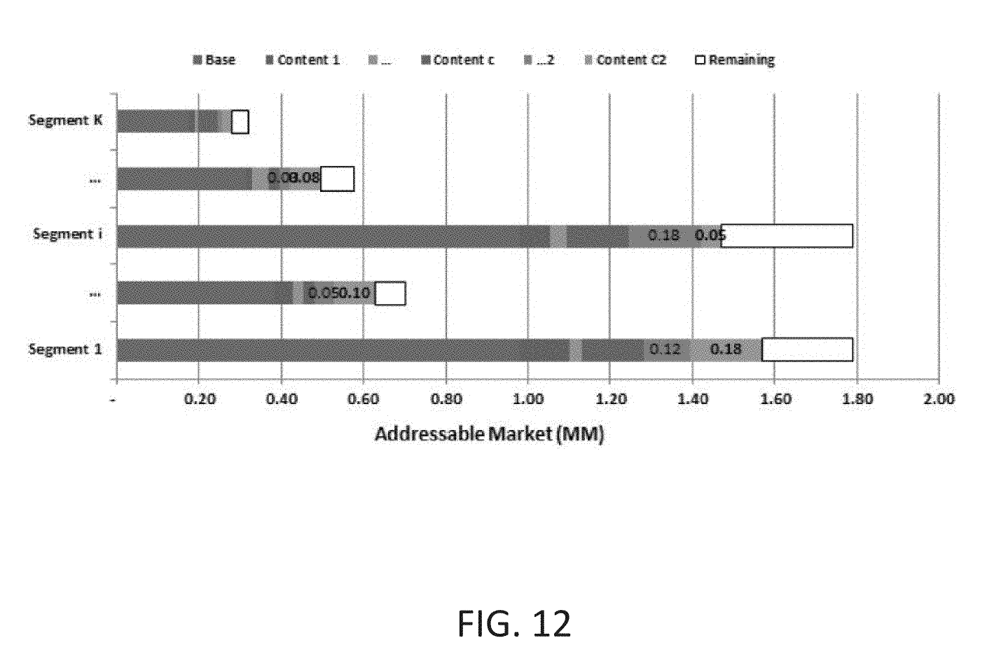

FIG. 12 illustrates a chart usable to track lift based on each segment compared to a total addressable market. Calculation of all partnerships can be performed in order to evaluate how each feature (e.g., software title sales/marketing, bundle sales) can contribute to the coverage of the addressable market. As illustrated in the figure, each segment corresponds to an addressable market in which the company may wish to determine an optimal distribution of resources for maximum penetration within that segment. Each segment includes a breakdown illustrating how each feature contributes to the coverage of the market. The end portion (illustrated as an empty white box) of each segment represents the remaining market that is to be covered.

The aspects of the presently claimed invention (as described in the steps) are usable in determining the distribution of the various features to maximize market penetration within each segment. Furthermore, if any of the addressable market is still unaccounted for (i.e. empty white box), implementation of the invention can be further used to maximize allocation of remaining resources for that remaining portion.

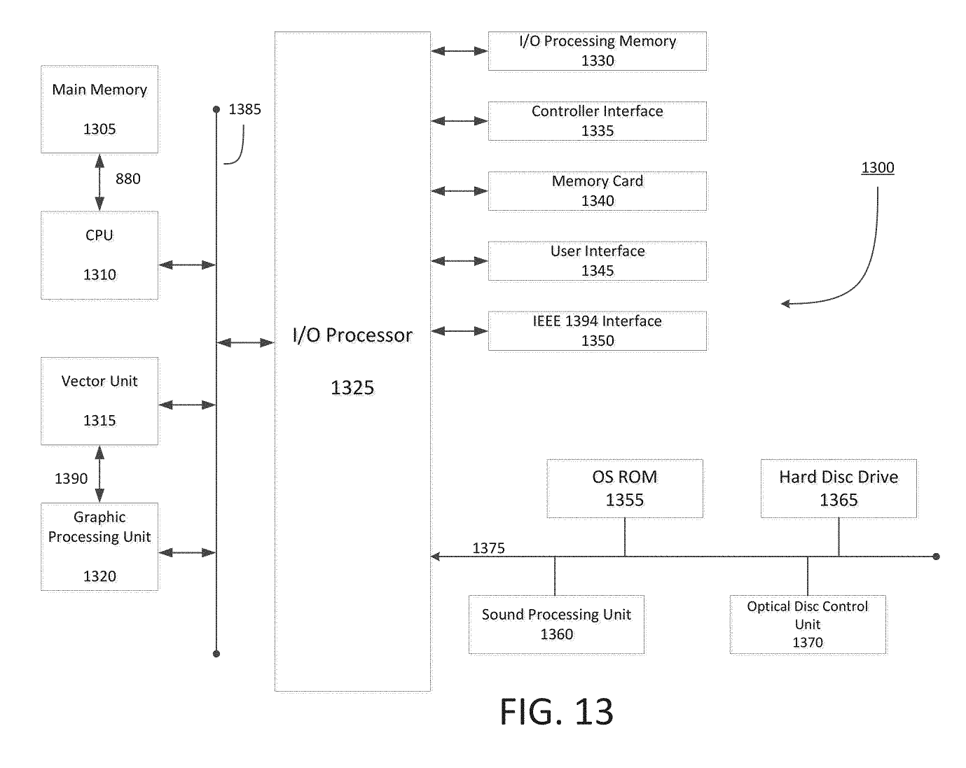

FIG. 13 is a block diagram of an exemplary system 1300. The system 1300 of FIG. 13 includes a main memory 1305, a central processing unit (CPU) 1310, vector unit 1315, a graphics processing unit 1320, an input/output (I/O) processor 1325, an I/O processor memory 1330, a controller interface 1335, a memory card 1340, a Universal Serial Bus (USB) interface 1345, and an IEEE 1394 interface 1350. The system 1300 further includes an operating system read-only memory (OS ROM) 1355, a sound processing unit 1360, an optical disc control unit 1370, and a hard disc drive 1365, which are connected via a bus 1375 to the I/O processor 1325.

The system 1300 may be implemented as a general-purpose computer, a set-top box, a tablet computing device, or a mobile computing device or phone. The systems may contain more or less operating components depending on a particular form factor, purpose, or design.

The CPU 1310, the vector unit 1315, the graphics processing unit 1320, and the I/O processor 1325 of FIG. 13 communicate via a system bus 1385. Further, the CPU 1310 of FIG. 13 communicates with the main memory 1305 via a dedicated bus 1380, while the vector unit 1315 and the graphics processing unit 1320 may communicate through a dedicated bus 1390. The CPU 1310 of FIG. 13 executes programs stored in the OS ROM 1355 and the main memory 1105. The main memory 1305 of FIG. 13 may contain pre-stored programs and programs transferred through the I/O Processor 1325 from a CD-ROM, DVD-ROM, or other optical disc (not shown) using the optical disc control unit 1370. I/O Processor 1325 of FIG. 13 may also allow for the introduction of content transferred over a wireless or other communications network (e.g., 4G, LTE, 3G, and so forth). The I/O processor 1325 of FIG. 13 primarily controls data exchanges between the various devices of the system 1300 including the CPU 1310, the vector unit 1315, the graphics processing unit 1320, and the controller interface 1335.

The graphics processing unit 1320 of FIG. 13 executes graphics instructions received from the CPU 1310 and the vector unit 1315 to produce images for display on a display device (not shown). For example, the vector unit 1315 of FIG. 13 may transform objects from three-dimensional coordinates to two-dimensional coordinates, and send the two-dimensional coordinates to the graphics processing unit 1320. Furthermore, the sound processing unit 1360 executes instructions to produce sound signals that are outputted to an audio device such as speakers (not shown). Other devices may be connected to the system 1300 via the USB interface 1345, and the IEEE 1394 interface 1350 such as wireless transceivers, which may also be embedded in the system 1300 or as a part of some other component such as a processor.

A user of the system 1300 of FIG. 13 provides instructions via the controller interface 1335 to the CPU 1310. For example, the user may instruct the CPU 1310 to store certain information on the memory card 1340 or other non-transitory computer-readable storage media or instruct the system 1300 to perform some specified action.

The foregoing detailed description of the technology herein has been presented for purposes of illustration and description. It is not intended to be exhaustive or to limit the technology to the precise form disclosed. Many modifications and variations are possible in light of the above teaching. For example, the descriptions applicable to platforms and software titles may not be restricted only to consoles. In some situations, the same invention can be usable for forecasting sales of other devices (e.g., multi-media players) by using forecasting information about related products (e.g., multi-media content) usable with the device. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

What is claimed:

1. A method of maximizing a projected number of sales of a platform based on forecasting and modeling projected sales of associated products in a constrained portfolio, the method comprising:
receiving a list of software titles, wherein the list of software titles includes internal software titles;
receiving a list of bundles, wherein the list of bundles includes internal bundles;
executing instructions stored in memory, the instructions being executed by a processor to:
forecast sales for each listed software title and each listed bundle,
identify an addressable market for a platform, wherein the addressable market includes a plurality of distinct consumer segments each having a unique set of characteristics,
receive characterization data regarding each listed software title, wherein the received characterization data includes characterization of each listed software title as a plurality of descriptive elements,
evaluate user preference of each descriptive element associated with each consumer segment of the addressable market,
calculate lift elements for the platform for each consumer segment associated with each listed software title and each listed bundle using the forecasted sales and characterization data, wherein the calculated lift elements are based on one or more different combinations of user input specifying how resources are used to promote the sale of the platform associated with each listed software title and each listed bundle, and
verify that the calculated lift elements based on the different combination of user input satisfies one or more constraints, wherein the one or more constraints includes limitations on an the available resources usable to promote the sale of the platform; and
outputting a combination of user input that specifies how the available resources could be used to best promote the sale of the platform.

2. The method of claim 1, wherein the list of software titles also includes software titles associated with a competitor.

3. The method of claim 1, wherein the list of software titles also includes software titles obtained from third parties via an exclusive partnership agreement.

4. The method of claim 1, wherein the list of bundles also includes bundles associated with a competitor.

5. The method of claim 1, wherein the list of bundles also includes products associated with a third party.

6. The method of claim 1, wherein the unique set of characteristics for the consumer segment includes characterizations for users who already own one or more platforms, users who may have a propensity to switch between platforms, and user associations with a particular platform.

7. The method of claim 1, wherein the plurality of descriptive elements for a software title includes descriptions as to the type of story, perspective, genre, ESRB rating, pacing, existence of multiplayer, or customization.

8. The method of claim 7, wherein each software title of the list of software titles have different combinations of the descriptive elements.

9. The method of claim 1, wherein the user input specifying how resources are used corresponds to resources spent on obtaining partnership agreements with third parties.

10. The method of claim 1, wherein the user input specifying how resources are used corresponds to resources spent on promoting sales via marketing campaigns.

11. The method of claim 1, wherein one or more constraints includes an available budget.

12. The method of claim 1, wherein a selected combination based on the best promotion of sales for the platform is based on a pre-determined threshold of platform sales that is desired.

13. The method of claim 1, wherein the received list of software titles includes a list of third party titles associated with an exclusive/partnership agreement.

14. The method of claim 13, wherein the exclusive/partnership agreement is directed towards having the software title playable only on the platform.

15. The method of claim 13, wherein the exclusive/partnership agreement is directed towards having the software title include content obtainable only when the software title is played on the platform.

16. A non-transitory computer-readable storage medium, having embodied thereon a program executable by a processor to perform a method of maximizing a projected number of sales of a platform based on forecasting and modeling projected sales of associated products in a constrained portfolio, the method comprising:
receiving a list of software titles, wherein the list of software titles includes internal software titles;
receiving a list of bundles, wherein the list of bundles includes internal bundles;
forecasting sales for each listed software title and each listed bundle;
identifying an addressable market for a platform, wherein the addressable market includes a plurality of distinct consumer segments each having a unique set of characteristics;
receiving characterization data regarding each listed software title, wherein the received characterization data includes characterization of each listed software title as a plurality of descriptive elements;
evaluating user preference of each descriptive element associated with each consumer segment of the addressable market;
calculating lift elements for the platform for each consumer segment associated with each listed software title and each listed bundle using the forecasted sales and characterization data, wherein the calculated lift elements are based on one or more different combinations of user input specifying how resources are used to promote the sale of the platform associated with each listed software title and each listed bundle;
verifying that the calculated lift elements based on the different combination of user input satisfies one or more constraints, wherein the one or more constraints includes limitations on an the available resources usable to promote the sale of the platform; and
outputting a combination of user input that specifies how the available resources could be used to best promote the sale of the platform.

17. A system for maximizing a projected number of sales of a platform based on forecasting and modeling projected sales of associated products in a constrained portfolio, the system comprising:
memory, and
a processor that executes instructions stored in memory, the instructions being executed by the processor to:
receive a list of software titles, wherein the list of software titles includes internal software titles;
receive a list of bundles, wherein the list of bundles includes internal bundles;
forecasting sales for each listed software title and each listed bundle;
identify an addressable market for a platform, wherein the addressable market includes a plurality of distinct consumer segments each having a unique set of characteristics;
receiving characterization data regarding each listed software title, wherein the received characterization data includes characterization of each listed software title as a plurality of descriptive elements;
evaluate user preference of each descriptive element associated with each consumer segment of the addressable market;
calculate lift elements for the platform for each consumer segment associated with each listed software title and each listed bundle using the forecasted sales and characterization data, wherein the calculated lift elements are based on one or more different combinations of user input specifying how resources are used to promote the sale of the platform associated with each listed software title and each listed bundle;
verify that the calculated lift elements based on the different combination of user input satisfies one or more constraints, wherein the one or more constraints includes limitations on an the available resources usable to promote the sale of the platform; and
output a combination of user input that specifies how the available resources could be used to best promote the sale of the platform.
